(19) United States
(12) Patent Application Publication
(10) Pub. No.: US 2012/0027891 A1
(43) Pub. Date: Feb. 2, 2012

(54) CONSUMABLE DISSOLVING FILM COMPRISING ACTIVE INGREDIENTS DERIVED FROM BACTERIA AND FUNGI

(75) Inventors: John G. Tobin, Mays Landing, NJ (US); Massoud Arvanaghi, Franklin Lakes, NJ (US)

(73) Assignee: NUTRAFOOD NUTREIENTS, INC., Pleasantville, NJ (US)

(21) Appl. No.: 13/142,405

(22) PCT Filed: Jan. 13, 2010
(86) PCT No.: PCT/US10/20912

§ 371 Date: Aug. 22, 2011

Related U.S. Application Data
(60) Provisional application No. 61/144,582, filed on Jan. 14, 2009.
(60) Provisional application No. 61/221,393, filed on Jun. 29, 2009.

(51) Int. Cl. A23L 1/29; A23L 1/302; A23L 1/303; A23L 1/0534; A23L 1/05; A23L 1/0522; A23L 1/0532; A23L 1/28; A23L 1/304

(52) U.S. Cl. 426/62; 426/61; 426/575

(57) ABSTRACT

A consumable film composition comprising a film base, an active ingredient and optionally a flavor agent, wherein the active ingredient is derived from bacteria or fungi or a combination thereof, is described.

### CROSS REFERENCE TO RELATED APPLICATIONS

This application claims the benefit of priority to U.S. Provisional Patent Application No. 61/144,582 filed Jan. 14, 2009, and U.S. Provisional Patent Application No. 61/221,393, filed Jun. 29, 2009, both of which are hereby incorporated by reference in their entirety.

### BACKGROUND OF THE INVENTION

1. Field of the Invention

The invention relates to consumable dissolving film comprising active ingredients derived from bacteria and fungi.

2. Related Art

Probiotic products are known. Probiotics are dietary supplements and food products containing potentially beneficial bacteria or yeasts. Lactic acid bacteria (LAB) is a common type of microbe used in probiotic products. Lactobacillus and Bifidobacterium are the most frequently used probiotic bacteria. Potential therapies for probiotic bacteria include managing lactose intolerance, treating irritable bowel syndrome and traveler's diarrhea, lowering cholesterol, improving the immune system and preventing infections. They also are considered beneficial on account of the vitamins and minerals the bacteria produce. Some probiotics are in the form of food products, such a yoghurt or milk. Others are administered in the form of beadlets, capsules or tablets, all of which are commercially available.

Nutraceuticals containing vitamins and minerals produced by biological sources are also known. For instance, the Netherlands' based food science institute, NIZO, identified bacteria that produce high amounts of vitamins into their surroundings, such as into dairy products. Through a selection process, it was possible to identify high yielding bacteria that do not consume much of the vitamins they produce. It is known, for instance, that in humans, enteric bacteria secrete Vitamin K and Vitamin B12, and lactic acid bacteria produce certain B-vitamins.

Vitamins have been formulated in many different ways, including tablets, fluids, capsules and beadlets to be delivered orally to the digestive tract. It is also known that vitamins can be delivered directly into the blood stream from tablets used sublingually.

It is also known that certain types of films will dissolve in the mouth. Such film have been used to deliver therapeutics and breath fresheners, as described in U.S. Pat. No 6,177,096 and U.S. Pat. No. 6,923,981. Rapidly dissolving films also have been described for the delivery of nutraceuticals comprising xanthones in U.S. Pat. No. 7,182,964. U.S. Pat. No. 7,097,869 discloses the production of nutraceutical chips, which are thin, dried polymer gel products comprising vegetables, fruits, seeds, nuts and seaweed.

Although edible thin film technology is known, it has not been used for the delivery of active ingredients, such as vitamins and minerals, that are derived from bacteria and fungi. Bacteria and fungi derived nutraceuticals have the disadvantage of added mass when compared to isolated US Pharmacopeia vitamins and minerals. Because a dissolving film necessarily contains a limited amount of material in order to function, it was not expected that nutraceuticals derived from fungi and bacteria, which have greater mass, could be delivered in thin, dissolving films in amounts sufficient to be equivalent to isolated vitamins and minerals. It was, in fact, surprising that because nutraceuticals derived from bacteria and fungi are better absorbed, utilized and retained in the body, smaller amounts could be used effectively.

### SUMMARY OF THE INVENTION

In one embodiment, the invention is directed to a consumable film composition comprising a film base, an active ingredient and optionally a flavor agent, wherein the active ingredient comprises vitamins and/or minerals derived from bacteria or fungi or a combination thereof. In one embodiment, the active ingredients may be at least one of Beta-carotene, Biotin, Choline, Vitamin E, Calcium, Copper, Chromium, Folic acid, Inositol, Iron, Magnesium, Manganese, Molybdenum, Phosphorus, Potassium, Selenium, Vitamin B1, Vitamin B2, Vitamin B6, Vitamin B12, Vitamin C, Vitamin D, Vitamin D3, Zinc, Superoxide Dismutes (SOD), Glutathione, Beta-glucans, Manose, Vitamin K, Protein, Boron, Cobalt, Glucose Tolerance Factor Chromium, Iodine, Lithium, Silicon, Strontium, Tin, Vanadium Glutathionine, Niacin Amide, Pantothenic Acid, Bioflavinoids, PABA, Coenzyme Q10 (CoQ10), and green tea extracts.

Such active ingredient(s) may be derived from gram positive facultative anaerobic or microaerophilic bacteria. Such bacteria may be Lactobacillus and any strain or variant thereof, including Lactobacillus bulgaricus, Lactobacillus acidophilus, Lactobacillus caucasicus, Lactobacillus bifidus, Lactobacillus casei Shirota, Lactobacillus casei DN-114 001, Lactobacillus rhamnosus GR-1, Lactobacillus reuteri, Lactobacillus reuteri 55730, and combinations thereof. In another embodiment, the bacteria may be Bifidobacterium animalis DN-173010, Bifidobacterium infantis 35624, Bifidobacterium lactis Bb-12 and all strains and variants thereof. In another embodiment, the active ingredient may be derived from a fungus or a combination of a fungus and bacteria. A fungus suitable for the present invention includes Saccharomyces cerevisiae and Saccharomyces boulardii and all strains and variants and combinations thereof.

In one embodiment, the film base may be a water soluble polymer, including but not limited to at least one of a soluble polymer selected from the group consisting of amylose, arabic gum, carboxymethyl cellulose, carboxyvinyl polymers, collagen, dextrin, gluten, guar gum, acacia gum, high amylose starch, hydroxyethyl cellulose, hydroxypropyl cellulose, hydroxypropylated high amylose starch, hydroxypropylmethyl cellulose, methylmethacrylate copolymers, polyacrylic acid, polyethylene glycol, polyvinyl alcohol, polyvinyl pyrrolidone, pullulan, sodium alginate, tragacanth gum and whey protein isolate.

A flavor agent may be either natural or artificial.

The consumable film of the invention may further comprise: at least one saliva inducing agent; at least one ingredient selected from the group consisting of surfactants, stabilizing agents, emulsifiers, thickeners, plasticizers, antimicrobials, water, water soluble polymers, binders, polyethylene oxides, propylene glycols, sweeteners, flavor enhancers, colorants, polyalcohols, and combinations thereof.

In one embodiment, the invention is directed to a consumable film composition comprising bacteria and fungi derived Vitamin C, Vitamin E, folic acid, biotin, niacinamide, pantothenic acid, choline, inositol, PABA, Vitamin D3, Vitamin U, zinc, copper, sulfur and additionally green tea, carboxymethylcellulose, modified corn starch, maltodextirin, propylene glycol, glycerin, polysorbate 80, sodium alginate, soy lecithin, sucralose, acesulfame potassium and chocolate mint flavoring.

In another embodiment, the invention is directed to a consumable film composition comprising dried powdered green tea leaf, stevia leaf powder, alginate cellulose base and natural green tea flavoring.

In yet another embodiment, the invention is directed to a consumable film composition comprising bacteria and fungi derived Vitamin D3 and sodium alginate, sorbitol, glycerin, corn starch, modified corn starch, natural flavor, sodium carboxymethylcellulose, polysorbate 80, lecithin, sucralose, and acesulfame potassium and raspberry flavoring.

In yet another embodiment, the invention is directed to a consumable film composition comprising bacteria and fungi derived Vitamin D3 and green tea, sodium alginate, sorbitol, glycerin, corn starch, modified corn starch, natural flavor, sodium carboxymethylcellulose, polysorbate 80, lecithin, sucralose, and acesulfame potassium.

### DETAILED DESCRIPTION

The present invention relates to a consumable film composition comprising a film base, an active ingredient and optionally a flavor agent, wherein the active ingredient is derived from bacteria or fungi or a combination thereof. In one embodiment, the active ingredient is at least one vitamin or mineral derived from bacteria, fungi or a combination thereof.

By “consumable” is meant that the film may be safe for human and animal consumption. However, this term should also be interpreted as meaning that the film of the invention may be safely used orally or at body sites other than the mouth, for instance in the nose, eye, on skin and wound sites anywhere on the body, and on any mucosal linings including the lower digestive tract or the in the vagina.

By “film base” is meant a substrate that dissolves rapidly in the mouth, including those described in U.S. Pat. Nos. 6,824,829 and 7,241,411, which are herein incorporated by reference. Such bases may be water soluble polymers, which include but are not limited to amylase, Arabic gum, carboxymethyl cellulose, carboxyvinyl polymers, collagen, dextrin, gluten, guar gum, pectin, xanthan gum, tragacanth gum, chitin, chotosan, levan, elsinan, acacia gum, high amylase starch, hydroxypropylethyl cellulose, hydroxyethyl cellulose, hydroxypropyl cellulose, hydroxypropylated high amylase starch, hydroxymethyl cellulose, hydroxypropylmethyl cellulose, methylmethacrylate copolymers, polyacrylic acid, polyethylene glycol, polyvinyl alcohol, polyvinyl pyrrolidone, pullulan, sodium alginate, casein, whey protein isolate, soy protein isolate, gelatin, hydrocolloid flours, sea weed extracts, land plant extracts and derivatives and combinations thereof. In one embodiment, the film base is a cellulose base. In the finished product, the film must be thin and rapidly dissolving but flexible enough to withstand packaging, storage and transport. The film may contain plasticizers, binding agents and other additives as described in U.S. Pat. Nos. 6,824,829 and 7,241,411.

By the term “active ingredient” is meant at least one biologically active substance, such as a nutrient, vitamin and/or mineral that is grown, metabolized and/or fermented in any single cell organism, including but not limited to Lactobacillus bulgaricus (yogurt cultured), and Saccharomyces cerevisiae (yeast cultured) and Baker's and/or Brewer's yeast or any combination thereof.

Thus, in one embodiment, the active ingredient comprises vitamins and/or minerals derived from gram positive facultative anaerobic or microaerophilic bacteria or fungi or a combination thereof. Such bacteria may be Lactobacillus and all strains and variants thereof, including Lactobacillus bulgaricus, Lactobacillus acidophilus, Lactobacillus caucasicus, Lactobacillus bifidus, Lactobacillus casei Shirota, Lactobacillus casei DN-114 001, Lactobacillus rhamnosus GR-1, Lactobacillus reuteri, Lactobacillus reuteri 55730, and combinations thereof. In another embodiment, the bacteria may be Bifidobacterium animalis DN-173010, Bifidobacterium infantis 35624, Bifidobacterium lactis Bb-12 and variants thereof. In another embodiment, the active ingredient may be derived from fungi or a combination of fungi and bacteria. Fungi suitable for the present invention includes Saccharomyces and all strains and variants thereof including Saccharomyces cerevisiae and Saccharomyces boulardii and combinations thereof.

The active ingredients derived from a bacteria or fungus according to the invention include but are not limited to Beta-carotene, Biotin, Choline, Vitamin E, Calcium, Copper, Chromium, Folic acid, Inositol, Iron, Magnesium, Manganese, Molybdenum, Phosphorus, Potassium, Selenium, Vitamin B1, Vitamin B2, Vitamin B6, Vitamin B12, Vitamin C, Vitamin D, Zinc, Superoxide Dismutes (SOD), Glutathione, Coenzyme Q10 (CoQ10), Beta-glucans, Manose, Vitamin K, Protein, Boron, Cobalt, Glucose Tolerance Factor Chromium, Iodine, Lithium, Silicon, Strontium, Tin, Vanadium Glutathionine, Niacin Amide, Pantothenic Acid, Bioflavinoids, PABA and natural dietary fibers, such as cellulose and other plant fiber. The active ingredient may also include a biologically active substance such as a chemical compound, a nutrient or a mineral that is not derived from, i.e, not produced, excreted or fermented by a bacteria or fungi. For instance, in one embodiment, Vitamin U (3-Amino-3, carboxypropyl) dimethyl sulfonium chloride or cabagin may be included in the active ingredient.

Other examples of active ingredients that may or may not be derived from bacteria or fungi are green tea and various components of green tea, such as epigallocatechin gallate, and extracts from, and powder and fiber forms of other plants, including but not limited to ginger, mushrooms, including the Maitake mushrooms, cocoa, coffee, grape seed, black currant, boysenberry, kiwi, pomegranate, Hericium erinaceum, and the bark of trees. Examples of other active ingredients include procyanidin and proanthocyanidins, from the bark of the maritime pine, Pinus maritime. Yet other active ingredients include, chlorogenic acid, caffeic acid, ferulic Acid, quinic acid, trigonelline, glutathione, L-theonine, D-alpha tocopheryl polyethylene glycol 1000 succinate, resveratrol, salicate, soy, polyphenols, mangostin, silymarin, silybin, ginsenosides, punicalagins, punicic acid, rosavins, salidroside, phloridzin, isoflavones, glucosamine, hypercin, caffeine and flavanols, ashwagandhaa extracts, such as withanolides.

By the term “derived from a fungus or bacterium” is meant that the active ingredient is either a natural part of a fungus or bacterium, is delivered by or naturally produced by the bacterium or fungus or becomes part of the bacterium or fungus or is produced by the bacterium or fungus through an enrichment process of metabolization or fermentation. Specifically, in this enrichment process of metabolization or fermentation, active ingredients, such as vitamins and minerals are fed into the culture medium of bacteria or fungi and are thereby incorporated into the bacteria or fungi. Active ingredients such as vitamins may be introduced into a culture medium by way of mineral salts or complexation with a food concentrate. Methods of culturing bacteria and fermenting fungi are known to the skilled artisan.

After the appropriate culturing and growth process, the bacteria or fungi are harvested and purified by any means known to the skilled artisan. For instance, the harvested bacteria or fungi may be washed multiple times with purified water. The purified product is then disintegrated by any means known to the skilled artisan, such as by mechanical means or by treatment with enzymes. After disintegration, the product is dried into a powder. This product may be combined with other powders similarly produced from other types of bacteria or fungus or from other nutrient driven systems to form a combination product. Additional active ingredients not derived from bacteria or fungi also may be added to the powder product. The product may be pasteurized. The product is tested for purity and safety. The dried powder should be fine enough to permit absorption into the body. One of skill in the art would know that the size of the powder particles could be controlled with meshes of varying sizes. In one embodiment, the powder is filtered through a mesh size of 20 to 140. In a preferred embodiment, the mesh size is from 60 to 80.

In one embodiment, the amount of the active agent is from 1 to 90 percent by weight of the total consumable film, preferably from about 20 to about 80 percent by weight, and most preferably from about 40 to about 60 percent by weight of the consumable film. In one embodiment, the active agent comprises from about 45 to 55 percent by weight of the film. One of skill in the art would understand that the amount of the active agent could be adjusted depending upon the nature of the active agent and the target population. For instance, in one embodiment, the consumable film of the invention is intended for use in children or infants. Accordingly, the amount of the active ingredient would be different than for use in adults. Also impacting the amount of the active ingredient would be the health and condition of the target group. Those of skill in the art would know how to make the appropriate adjustments to provide a proper dosage while maintaining the proper flavor, taste and structural features of the dissolving film. In one embodiment, the consumable film of the invention is intended for use at body sites other than the mouth and in such cases the amount of active agent would vary depending upon the intended site of application. One of skill in the art would understand how to make such adjustments.

Flavor agents, according to the invention, are those well known to the skilled artisan and can be natural, such as green tea, or synthetic, flavor oils and flavoring aromatics, and/or oils, oleo resins and extracts derived from plants, leaves, flowers, fruits and so forth, and combinations thereof. Representative flavor oils include: spearmint oil, cinnamon oil, peppermint oil, clove oil, bay oil, thyme oil, cedar leaf oil, oil of nutmeg, oil of sage, and oil of bitter almonds. Also useful are artificial, natural or synthetic fruit flavors such as vanilla, chocolate, coffee, cocoa and citrus oil, including lemon, orange, grape, lime and grapefruit and fruit essences including apple, pear, peach, strawberry, raspberry, cherry, plum, pineapple, apricot and so forth. These flavorings can be used individually or in admixture. Commonly used flavors include mints such as peppermint, artificial vanilla, cinnamon derivatives, and various fruit flavors, whether employed individually or in admixture. Flavorings such as aldehydes and esters including cinnamyl acetate, cinnamaldehyde, citral, diethylacetal, dihydrocarvyl acetate, eugenyl formate, p-methylanisole, and so forth may also be used. Generally, any flavoring or food additive, such as those described in Chemicals Used in Food Processing, publication 1274 by the National Academy of Sciences, pages 63-258, may be used. Further examples of aldehyde flavorings include, but are not limited to acetaldehyde (apple); benzaldehyde (cherry, almond); cinnamic aldehyde (cinnamon); citral, i.e., alpha citral (lemon, lime); neral, i.e. beta citral (lemon, lime); decanal (orange, lemon); ethyl vanillin (vanilla, cream); heliotropine, i.e., piperonal (vanilla, cream); vanillin (vanilla, cream); alpha-amyl cinnamaldehyde (spicy fruity flavors); butyraldehyde (butter, cheese); valeraldehyde (butter, cheese); citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, i.e. trans-2 (berry fruits); tolyl aldehyde (cherry, almond); veratraldehyde (vanilla); 2,6-dimethyl-5-heptenal, i.e. melonal (melon); 2-6-dimethyloctanal (green fruit); and 2-dodecenal (citrus, mandarin); cherry; grape; mixtures thereof; and the like. Preferred flavor agents are chocolate, mint, cherry, raspberry, orange, vanilla, lemon, lime, blackberry, grape and combinations thereof.

The amount of flavoring employed is based on preference subject to such factors as flavor type, individual flavor, and strength. Thus, the amount may be varied in order to obtain the result desired in the final product. Such variations are within the capabilities of those skilled in the art without the need for undue experimentation. In general, amounts of about 0.1 to about 30 wt % are useable with amounts of about 2 to about 25 wt % being preferred and amounts from about 8 to about 10 wt % are more preferred.

In yet another embodiment, the consumable film of the invention may have flavorings that are attractive to animals, such as dogs and cats. Thus, the consumable film of the invention may be appropriate for delivering active ingredients, such as vitamins and minerals, to pets. Suitable flavoring may be natural or artificial beef, chicken or fish flavorings.

In yet another embodiment, the consumable film of the invention would not contain a flavoring agent. In such cases, the consumable film may be intended for use in body sites other than the mouth. In other cases, additional flavoring is unnecessary as some of the active ingredients may have a natural flavor, such as green tea and certain fruit products.

The consumable film of the present invention also may include a saliva inducing agent. Useful saliva inducing or stimulating agents are those disclosed in U.S. Pat. No. 4,820,506, which is incorporated by reference herein in its entirety. Saliva stimulating agents include food acids such as citric, lactic, malic, succinic, ascorbic, adipic, fumaric and tartaric acids. Preferred food acids are citric, malic and ascorbic acids. The amount of saliva stimulating agents in the film is from about 0.01 to about 12 wt %, preferably about 1 wt % to about 10 wt %, even more preferably about 2.5 wt % to about 6 wt %.

The consumable film of the present invention also may comprise a plasticizing agent. Preferred plasticizing agents include triacetin in amounts ranging from about 0 to about 20 wt %, preferably about 0 to about 2 wt %. Other suitable plasticizing agents include monoacetin and diacetin.

In one embodiment, the consumable film may comprise a cooling agent. Cooling agents include monomenthyl succinate, in amounts ranging from about 0.001 to about 2.0 wt %, preferably about 0.2 to about 0.4 wt %. A monomenthyl succinate containing cooling agent is available from Mane, Inc. Other suitable cooling agents include WS3, WS23, Ultracool II and the like.

The consumable film of the present invention also may include a surfactant. Preferred surfactants include mono and diglycerides of fatty acids and polyoxyethylene sorbitol esters, such as, Atmos 300 and Polysorbate 80. The surfactant can be added in amounts ranging from about 0.5 to about 15 wt %, preferably about 1 to about 5 wt % of the film. Other suitable surfactants include pluronic acid, sodium lauryl sulfate, and the like.

The consumable film of the present invention also may comprise a stabilizing agent. Preferred stabilizing agents include xanthan gum, locust bean gum and carrageenan, in amounts ranging from about 0 to about 10 wt %, preferably about 0.1 to about 2 wt % of the film. Other suitable stabilizing agents include guar gum and the like.

The consumable film of the present invention also may comprise an emulsifier. Preferred emulsifying agents include triethanolamine stearate, quaternary ammonium compounds, acacia, gelatin, lecithin, bentonite, veegum, and the like, in amounts ranging from about 0 to about 5 wt %, preferably about 0.01 to about 0.7 wt % of the film.

The consumable film of the invention may comprise a thickening agent. Examples of thickening agents suitable for use in the invention include, methylcellulose, carboxyl methylcellulose, and the like, in amounts ranging from about 0 to about 20 wt %, preferably about 0.01 to about 5 wt %. One of skill in the art of the invention would know of other thickening agents.

The consumable film of the present invention also may comprise a binding agent. Preferred binding agents include starch such as corn starch, in amounts ranging from about 0 to about 10 wt %, preferably about 0.01 to about 2 wt % of the film. One of skill in the art would know of other binding agents suitable for use in the invention.

In one embodiment, the present invention may comprise a sweetener. One of skill in the art would understand which sweeteners, both natural, such as stevia leaf extract, and artificial, would be suitable for use in the invention. Suitable sweeteners include water-soluble sweetening agents such as monosaccharides, disaccharides and polysaccharides such as xylose, ribose, glucose (dextrose), mannose, galactose, fructose (levulose), sucrose (sugar), maltose, invert sugar (a mixture of fructose and glucose derived from sucrose), partially hydrolyzed starch, corn syrup solids, dihydrochalcones, monellin, steviosides, and glycyrrhizin. Other types of sweeteners are water-soluble artificial sweeteners such as the soluble saccharin salts, i.e., sodium or calcium saccharin salts, cyclamate salts, the sodium, ammonium or calcium salt of 3,4-dihydro-6-methyl-1,2,3-oxathiazine-4-one-2, 2-dioxide, the potassium salt of 3,4-dihydro-6-methyl-1,2,3-oxathiazine-4-one-2,2-dioxide (acesulfame-K), the free acid form of saccharin, and the like. There are also dipeptide based sweeteners, such as L-aspartic acid derived sweeteners, such as L-aspartyl-L-phenylalanine methyl ester (aspartame) and materials described in U.S. Pat. No. 3,492,131, L-alpha-aspartyl-N-(2,2,4,4-tetramethyl-3-thietanyl)-D-alaninamide hydrate, methyl esters of L-aspartyl-L-phenylglycerin and L-aspartyl-L-2,5,dihydrophenyl-glycine, L-aspartyl-2,5-dihydro-L-phenylalanine, L-aspartyl-L-(1-cyclohexyen)-alanine, and the like. Additionally, there are water-soluble sweeteners derived from naturally occurring water-soluble sweeteners, such as a chlorinated derivative of ordinary sugar (sucrose), known, for example, under the product description of sucralose. Finally, one of skill in the art would be familiar with protein based sweeteners such as thaumatoccous daniellii (Thaumatin I and II).

The amount of sweetener will vary depending upon which sweetener is selected. This amount will normally be 0.01% to about 10% by weight of the composition when using an easily extractable sweetener. The water-soluble sweeteners described above are usually used in amounts of about 0.01 to about 10 wt %, and preferably in amounts of about 2 to about 5 wt %. Some of the water soluble sweeteners (e.g., glycyrrhizin) can be used in amounts set forth below due to the sweeteners' known sweetening ability. In contrast, the sweeteners described below are generally used in amounts of about 0.01 to about 10 wt %, with about 2 to about 8 wt % being preferred and about 3 to about 6 wt % being most preferred. These amounts may be used to achieve a desired level of sweetness independent from the flavor level achieved from any optional flavor oils used.

Of course, sweeteners need not be added to films intended for non-human or non-oral administration. Although the preferred embodiment relates to use of the consumable film in the oral cavity, in other embodiments, the film of the invention is not for oral consumption but may be applied to any body site wherein the ingredients can be absorbed through skin or tissue or a body lining. For instance, in one embodiment, the invention is used at wound sites anywhere in the body. In such cases, the film may be molded to fit a particular part of the body. In another embodiment, the film of the invention may be applied to the eye or nasal, vaginal or anal tissue.

The consumable film of the present invention also may comprise colorants. One of skill in the art would know which coloring agents would be appropriate in what amounts. That is, one of skill in the art would know that coloring agents are used in amounts effective to produce the desired color. The coloring agents useful in the present invention, include but are not limited to pigments such as titanium dioxide, which may be incorporated in amounts of up to about 5 wt %, and preferably less than about 1 wt %. Colorants can also include natural food colors and dyes suitable for food, drug and cosmetic applications. These colorants are known as FD&C dyes and lakes. The materials acceptable for the foregoing spectrum of use are preferably water-soluble, and include FD&C Blue No. 2, which is the disodium salt of 5,5-indigotindisulfonic acid. Similarly, the dye known as Green No. 3 comprises a triphenylmethane dye and is the monosodium salt of 4-[4-N-ethyl-p-sulfobenzylamino) diphenyl-methylene]-[1-N-ethyl-N-p-sulfonium benzyl)-2,5-cyclo-hexadienimine]. A full recitation of all FD&C and D&C dyes and their corresponding chemical structures may be found in the Kirk-Othmer Encyclopedia of Chemical Technology, Volume 5, Pages 857-884, which text is accordingly incorporated herein by reference.

The present invention is also directed to methods of producing consumable films comprising active ingredients derived from bacteria or fungi or combinations thereof. It is contemplated that the films of the invention are made in large scale, commercial quantities using industrial equipment and methods known to the art that can be adapted, as needed. The following example of a basic development and production process can be adjusted by one of skill in the art as needed to serve a particular goal or objective.

Laboratory Formulation:
Identify product for new delivery system of edible film
Choose Active Ingredient/Flavor combinations for specific benefit
Identify specific dosage amounts
Customize film bases—alginate, pectin, HMPC, pullulan, cellulose
Accommodate precise Active/Flavor constituent levels
Maximum film structure
Identify and customize flavor profile and color.

Pilot Scale Production:
Cast on Mylar supported web
Customize drying conditions
Precisely match color specifications
Confirm customized flavor profile
Begin Active constituent chemical assay method development.

Production Batch Preparation:
Mix solution in Pharmaceutical Standard Batch Process Vessels
Produce custom scale-up quantities
Ensure quality and reproducibility via GMP operations
Confirm Active Concentration on wet and dry basis
Produce three consecutive validation runs.

Manufacturing Line:
Mix solution in Pharmaceutical standard batch process vessels
Ensure uniform film thickness across web
Confirm customized drying conditions for zones and line speed
In-process quality control sampling and monitoring
Confirm that specifications meet customer's requirements
Confirm Active Constituents assay prior to packaging.

Slitting and Cutting Operation:
Age master roll
Slit and convert into canisters or single serve foil pouches
Label via two-sided labeling or wrap around label
Hot stamp lot and/or date code for traceability
Metal detection.

Packaging Operations:
Assemble single pouch into individual folding carton (IFC)
Assemble canister into single pouch
Assemble film seal/blister/card/pop tray
All display types available.

The active ingredient used in the above process is at least one vitamin or mineral derived from bacteria or fungi or a combination thereof and is in dry, powder form, as described above. One of skill in the art could obtain such powder commercially, for instance, from Grow Company, Inc. of Ridgefield, N.J., US. Although variations of the process may exist and applicants do not want to be limited to any particular series of steps, generally, the active ingredient is mixed with the selected base and this mixture is combined with other non-active ingredients such as flavors and saliva stimulants, as described above. The base with the active and non-active ingredients are then cast on a web machine to form a thin film. The thickness of the cast film is monitored and adjusted as is the subsequent drying so as to ensure that the resultant film is functional for delivering the active ingredient through dissolution in the mouth or other body site yet can maintain integrity during packaging and storage and transport.

It should be understood that the film of the invention can be made into any conformation that meets the criteria for delivery of the active ingredient, practical packaging, storage and transport. For instance, the film can be made into strips, dots or any other shapes, forms or sizes. In one embodiment, the film can be molded to cover a particular body site. In one embodiment, the film is molded to cover a burn wound.

The consumable film of the present invention is intended to deliver to animals active ingredients, such as nutraceuticals derived from bacteria and fungi. Preferably, the animals are humans. However, the films of the invention are also intended for veterinarian use. Animals, according to the invention, could be non-humans, such as domesticated animals, including dogs and cats or farm animals. The consumable film of the invention is also intended to deliver nutraceuticals to adults as well as children and infants. The consumable film is also intended to be used in populations of people who are averse to taking pills or tablets.

All of the above references and citations are hereby incorporated by reference in their entirety.

### EXAMPLES

The invention will be illustrated in more detail with reference to the following Examples, but it should be understood that the present invention is not deemed to be limited thereto.

### Example 1

Hair/Skin/Nails formulation: A strip is made comprising 123 mg per strip of a combination of bacteria and fungi derived Vitamin C, Vitamin E, folic acid, biotin, niacinamide, pantothenic acid, choline, inositol, PABA, Vitamin D3, Vitamin U, zinc, copper, and sulfur. Other ingredients include green tea and enzymatically modified carboxymethylcellulose, modified corn starch, maltodextirin, propylene glycol, glycerin, polysorbate 80, sodium alginate, soy lecithin, sucralose acesulfame potassium and chocolate mint for flavor.

### Example 2

Green Tea Formulation: Strips are made comprising 30 mg per strip of an active ingredient comprising green tea (leaf) powdered extract (dried) (Standardized to 90% [90 mg] polyphenols, 50% [50 mg] epigallocatechin gallate [EGCG]), stevia leaf powdered extract. Other ingredients include alginate cellulose base. The flavor of this strip is natural green tea.

### Example 3

Vitamin D3 Formulation: Strips are made comprising 1000 IU per strip of bacteria and fungi derived Vitamin D3. Other ingredients include sodium alginate, sorbitol, glycerin, corn starch, modified corn starch, natural flavor, sodium carboxymethylcellulose, polysorbate 80, lecithin, sucralose and acesulfame potassium. The flavor is raspberry.

### Example 4

Vitamin D3 and Green Tea Formulation: Strips are made comprising 400 IU per strip of bacteria and fungi derived Vitamin D3 with green tea. Other ingredients include sodium alginate, sorbitol, glycerin, corn starch, modified corn starch, natural flavor, sodium carboxymethylcellulose, polysorbate 80, lecithin, sucralose and acesulfame potassium. The flavor is green tea.

### Example 5

Skin & Body Anti-Aging/Super Antioxidant Support—Film Strip Formula: Saccharomyces cerevisiae derived (Superoxide dismutase (SOD), Glutathione, Beta-Glucans, Selenium, Glycoprotein [full spectrum of Amino Acids]), trans-Resveratrol.

### Other Ingredients: Carboxymethyl Cellulose, Glycerin, Natural and Artificial Flavor, Polysorbate 80, Sucralose, Purified Water.

### Example 6

Weight Loss Support—Film Strip Formula: Saccharomyces cerevisiae derived (SOD, Glutathione, Beta-Glucans, GTF Chromium, Vanadium, Glycoprotein [full spectrum of Amino Acids]), trans-Resveratrol.

### Other Ingredients: Carboxymethyl Cellulose, Glycerin, Natural and Artificial Flavor, Polysorbate 80, Sucralose, Purified Water.

### Example 7

Vitamin D3 Support—Film Strip Formula: Saccharomyces cerevisiae derived (SOD, Glutathione, Beta-Glucans, Vitamin D3, Glycoprotein [full spectrum of Amino Acids]). Other Ingredients: Carboxymethyl Cellulose, Glycerin, Natural and Artificial Flavor, Polysorbate 80, Sucralose, Purified Water.

### Example 8

Bone Support Film-Strip Formula: Saccharomyces cerevisiae derived (SOD, Glutathione, Beta-Glucans, Vitamin D3, Calcium, Magnesium, Glycoprotein [full spectrum of Amino Acids]), Medicago sativa derived (Vitamins K1, K2). Other Ingredients: Carboxymethyl Cellulose, Glycerin, Natural and Artificial Flavor, Polysorbate 80, Sucralose, Purified Water.

### Example 9

Energy Support with Mental Focus Enhancement—Film Strip Formula: Saccharomyces cerevisiae derived (SOD, Glutathione, Beta-Glucans, Glycoprotein [full spectrum of Amino Acids], Vitamins B1, B6, B3, B12), Glycine Max (Biotin, Choline, Inositol), Medicago sativa derived (Folic Acid), Lactobacillus bulgaricus derived (Vitamin B2), Quercetin. Other Ingredients: Carboxymethyl Cellulose, Glycerin, Natural and Artificial Flavor, Polysorbate 80, Sucralose, Purified Water.

### Example 10

Stress Relief with Energy & Mental Focus Enhancement—Film Strip Formula: Saccharomyces cerevisiae derived (SOD, Glutathione, Beta-Glucans, Glycoprotein [full spectrum of Amino Acids], Vitamins B1, B6, B3, B12), Glycine Max (Biotin, Choline, Inositol), Medicago sativa derived (Folic Acid), Lactobacillus bulgaricus derived (Vitamin B2), Quercetin. Other Ingredients: Carboxymethyl Cellulose, Glycerin, Natural and Artificial Flavor, Polysorbate 80, Sucralose, Purified Water.

### Example 11

Total Body Anti-Aging with Super Antioxidants Support—Film Strip Formula: Saccharomyces cerevisiae derived (SOD, Glutathione, Beta-Glucans, Selenium, Glycoprotein [full spectrum of Amino Acids]), trans-Resveratrol, Pycnogenol. Other Ingredients: Carboxymethyl Cellulose, Glycerin, Natural and Artificial Flavor, Polysorbate 80, Sucralose, Purified Water.

### Example 12

Weight Management Support—Film Strip Formula: Saccharomyces cerevisiae derived (SOD, Glutathione, Beta-Glucans, GTF Chromium, Vanadium, Glycoprotein [full spectrum of Amino Acids]), trans-Resveratrol, Irvingia. Other Ingredients: Carboxymethyl Cellulose, Glycerin, Natural and Artificial Flavor, Polysorbate 80, Sucralose, Purified Water.

What is claimed is:

1. A consumable film composition comprising a film base and at least one active ingredient derived from bacteria or fungi or a combination thereof.

2. The consumable film composition of claim 1, wherein the film base is a water soluble polymer.

3. The consumable film of claim 1, wherein the active ingredient is selected from the group consisting of Beta-carotene, Biotin, Choline, Vitamin E, Calcium, Copper, Chromium, Folic acid, Inositol, Iron, Magnesium, Manganese, Molybdenum, Phosphorus, Potassium, Selenium, Vitamin B1, Vitamin B2, Vitamin B6, Vitamin B12, Vitamin C, Vitamin D, Vitamin D3, Zinc, Superoxide Dismutes (SOD), Glutathione, Beta-glucans, Manose, Vitamin K, Protein, Boron, Cobalt, Glucose Tolerance Factor Chromium, Iodine, Lithium, Silicon, Strontium, Tin, Vanadium Glutathionine, Niacin Amide, Pantothenic Acid, Bioflavinoids, PABA, Coenzyme Q10 (CoQ10), green tea extracts and combinations thereof.

4. The consumable film of claim 1, wherein the active ingredient is derived from gram positive facultative anaerobic or microaerophilic bacteria.

5. The consumable film of claim 4, wherein the bacteria are Lactobacillus.

6. The consumable film of claim 5, wherein the bacteria are selected from the group consisting of Lactobacillus bulgaricus, Lactobacillus acidophilus, Lactobacillus caucasicus, Lactobacillus bifidus and combinations thereof.

7. The consumable film of claim 2, wherein the water soluble polymer is selected from the group consisting of amylose, arabic gum, carboxymethyl cellulose, carboxyvinyl polymers, collagen, dextrin, gluten, guar gum, acacia gum, high amylose starch, hydroxyethyl cellulose, hydroxypropyl cellulose, hydroxypropylated high amylose starch, hydroxypropylmethyl cellulose, methylmethacrylate copolymers, polyacrylic acid, polyethylene glycol, polyvinyl alcohol, polyvinyl pyrrolidone, pullulan, sodium alginate, tragacanth gum, whey protein isolate, and combinations thereof.

8. The consumable film composition of claim 1, wherein the active ingredient is derived from a fungus.

9. The consumable film composition of claim 8, wherein the fungus is Saccharomyces cerevisiae.

10. The consumable film composition of claim 9, wherein the active ingredient is further derived from Lactobacilli.

11. The consumable film composition of claim 1, further comprising a flavor agent selected from the group consisting of natural and artificial flavorings.

12. The consumable film composition of claim 1, further comprising: at least one saliva inducing agent; at least one ingredient selected from the group consisting of surfactants, stabilizing agents, emulsifiers, thickeners, plasticizers, antimicrobials, water, water soluble polymers, binders, polyethylene oxides, propylene glycols, sweeteners, flavor enhancers, colorants, polyalcohols, and combinations thereof.

13. The consumable film of claim 1, further comprising an active ingredient that is not derived from bacteria or fungi.

14. The consumable film of claim 11, wherein the flavoring agent is a fruit flavor.

15. A consumable film composition comprising fungi and bacteria derived Vitamin C, Vitamin E, folic acid, biotin, niacinamide, pantothenic acid, choline, inositol, PABA, Vitamin D3, Vitamin U, zinc, copper, sulfur, and also green tea, carboxymethylcellulose, modified corn starch, maltodextirin, propylene glycol, glycerin, polysorbate 80, sodium alginate, soy lecithin, sucralose, acesulfame potassium and chocolate mint flavoring.

16. The consumable film composition of claim 1, which is a strip.

17. A consumable film composition comprising dried powdered green tea leaf, stevia leaf powder, alginate cellulose base and natural green tea flavoring.

18. A consumable film composition comprising fungi and bacteria derived Vitamin D3 and also sodium alginate, sorbitol, glycerin, corn starch, modified corn starch, natural flavor, sodium carboxymethylcellulose, polysorbate 80, lecithin, sucralose, and acesulfame potassium and raspberry flavoring.
